(19) United States
(12) Patent Application Publication
(10) Pub. No.: US 2012/0236295 A1
(43) Pub. Date: Sep. 20, 2012

(54) METHOD OF MEASURING BENDING PERFORMANCE OF OPTICAL FIBER

(75) Inventors: Tetsuya Nakanishi, Yokohama-shi (JP); Toshiki Taru, Yokohama-shi (JP); Takuji Nagashima, Yokohama-shi (JP); Tatsuya Konishi, Yokohama-shi (JP); Kazuya Kuwahara, Yokohama-shi (JP); Makoto Ichikawa, Yokohama-shi (JP)

(73) Assignee: SUMITOMO ELECTRIC INDUSTRIES, LTD., Osaka-shi (JP)

(21) Appl. No.: 13/417,555

(22) Filed: Mar. 12, 2012

(30) Foreign Application Priority Data
Mar. 15, 2011 (JP) 2011-057023

(51) Int. Cl. G01N 21/59

(52) U.S. Cl. 356/73.1

(57) ABSTRACT

A method of measuring the bending performance of an optical fiber in a simple manner is provided. Power P₁ of light emitted from one end of the optical fiber when light is incident onto the other end of the optical fiber is measured under conditions where the optical fiber 1 is wound at a constant pitch by one layer on the circumferential side of a mandrel 2 and the overall circumference of the optical fiber 1 thus wound is covered with an index matching sheet 5. The refractive index of the index matching sheet 5 substantially matches with the refractive index of resin of the outermost layer of the optical fiber 1.

### BACKGROUND OF THE INVENTION

1. Field of the Invention

The present invention relates to a method of measuring bending performance of a resin coated optical fiber.

2. Description of the Background Art

Use of optical fibers having small bend loss has spread with the progress of FTTH (fiber to the home) in recent years. The bend loss of an optical fiber occurs due to bend of the optical fiber. Methods for measuring the bend loss of an optical fiber are specified in ITU-T G.650.1 5.6 “Test methods for the macrobend loss,” and also described in Japanese Patent Application Publication No. H1-203938, Japanese Patent Application Publication No. 2002-310850, and Japanese Patent Application Publication No. 2009-229120. According to these, a bend loss is measured by evaluating differences between transmitted power obtained when an optical fiber is not bent and that obtained when the optical fiber is bent.

As indicated in “Wavelength dependence of bend loss in monomode optical fibers: effect of the fiber buffer coating” by R. Morgan et al., Vol. 15, No. 17, Optics Left. p. 947 (1990), a bend loss is caused because a part of core mode is ejected to a cladding at a bending portion when an optical fiber bends, and a part of the light that has leaked to the cladding (whispering gallery mode) is recombined with the core mode by Fresnel reflection at the interface between a coating layer and air. At the time of such recombination, interference arises between the core mode and the whispering gallery mode, generating an oscillatory component at equal optical frequency spacing in transmission spectrum of the bent optical fiber. As a result, it is difficult to achieve exact measurement of the bend loss.

The smaller the bend radius of an optical fiber, the more remarkable the generation of whispering gallery mode. In recent years, the application of optical fibers in which a small attenuation under a small radius of curvature such as 5 mm or 7.5 mm is guaranteed has increased according to the development of FTTH. However, in the case of such a small radius of curvature, it is difficult to measure the bend loss accurately in a simple manner.

It is known that the whispering gallery mode can be released outside from an optical fiber that is wound around a mandrel if the Fresnel reflection and the total reflection are suppressed at the interface between air and the coating layer of the optical fiber by dipping it in an index-matching liquid. However, as compared with an ordinary measurement, dipping an optical fiber in an index-matching liquid takes time and labor, thereby increasing the working hour and manufacturing cost. Moreover, an additional problem will occur: for example, a product may easily get dirty because of the index-matching liquid.

### SUMMARY OF THE INVENTION

The object of present invention is to provide a method for measuring the bending performance of an optical fiber in a simple manner.

The method of the invention for measuring bending performance of an optical fiber e comprises: (1) a first step of measuring power P₀ of light emitted from one end of an optical fiber when light is incident onto the other end of the optical fiber under conditions where no bend loss occurs in the optical fiber; (2) a second step of winding the optical fiber around a mandrel with a diameter 2R and covering the overall outer circumference of such wound optical fiber with an index matching sheet and subsequently measuring power P₁ of light emitted from one end of the optical fiber when light is incident onto the other end of the optical fiber, whereas the refractive index of the index matching sheet substantially matches with the refractive index of resin in the outermost layer of the optical fiber; and (3) a third step of measuring, based on the power P₀ measured at the first step and the power P₁ measured at the second step, the bend loss of the optical fiber when the optical fiber is bent at the diameter 2R.

According to the method of the present invention for measuring bending performance of the optical fiber, preferably the difference between the refractive index of an index matching sheet and that of resin in the outermost layer of the optical fiber is ±0.3 or less, and more preferably the difference is ±0.1 or less. Preferably, the compression elasticity modulus of the index matching sheet is 50 N/mm² or less, and more preferably the compression elasticity modulus is 30 N/mm² or less. The index matching sheet can be made of any one selected from the group consisting of urethane gel, urethane elastomer, and UV resin.

### Effect of the Invention

According to the present invention, bending performance of an optical fiber can be measured in a simple manner.

### BRIEF DESCRIPTION OF THE DRAWINGS

FIGS. 1A and 1B are conceptional schematic diagrams illustrating a method for measuring bend loss of an optical fiber.

FIG. 2 is a graph showing the wavelength dependence of transmitted power P₀ of an optical fiber 1 measured at the first step and the wavelength dependence of transmitted power P₁ of the optical fiber 1 measured at the second step, respectively in a comparative example.

FIG. 3 is a graph showing the wavelength dependence of the difference P_{Bend} between the transmitted power Pₒ and the transmitted power P₁ of the optical fiber 1 in the comparative example.

FIG. 4 is a drawing illustrating a second step in an embodiment of the method of the present invention for measuring bending performance of an optical fiber.

FIG. 5 is a graph showing the wavelength dependence of the difference P_{Bend}, where a solid line shows the results of measurement done according to the method of this embodiment for measuring bending performance of an optical fiber, and a dashed line shows those of measurement done with a conventional method.

FIG. 6 is a drawing illustrating a part of section of a mandrel around which an optical fiber and an index matching sheet are wound at the second step in the method according to this embodiment of the present invention for measuring bending performance of an optical fiber.

### DETAILED DESCRIPTION OF THE INVENTION

Hereinafter, preferred embodiments of the present invention will be described in reference to the accompanying drawings. The drawings are provided for the purpose of explaining the embodiments and are not intended to limit the scope of the invention. In the drawings, an identical mark represents the same element so that the repetition of explanation may be omitted. The dimensional ratios in the drawings are not always exact.

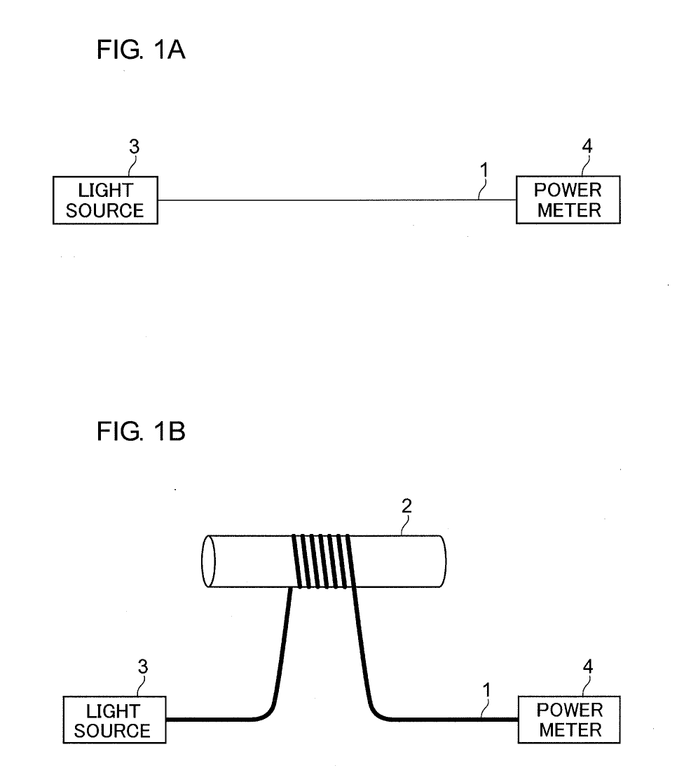

FIGS. 1A and 1B are conceptional schematic diagrams illustrating a method for measuring bend loss of an optical fiber. An optical fiber 1 to be measured has a core and a cladding which are respectively made of glass, and the circumference of the cladding is covered with a coating layer consisting of resin. The method of measuring the bend loss of an optical fiber comprises: (1) a first step of placing an optical fiber 1 under conditions where no bend loss will occur, and measuring power P₀ of light emitted from one end of the optical fiber 1 when light having a given power at a given wavelength is made incident on the other end of the optical fiber 1 from a light source 3 (FIG. 1A); (2) a second step of measuring, with a power meter 4, power P₁ of light emitted from one end of the optical fiber 1 when light is made on the other end of the optical fiber 1 incident from the light source 3 under conditions in which the optical fiber 1 is wound around a mandrel 2 with a given diameter (FIG. 1B); and (3) a third step of measuring, based on differences between the power P₀ measured at the first step and the power P₁ measured at the second step, the bend loss of the optical fiber 1 at a given wavelength when the optical fiber 1 is bent at a given diameter.

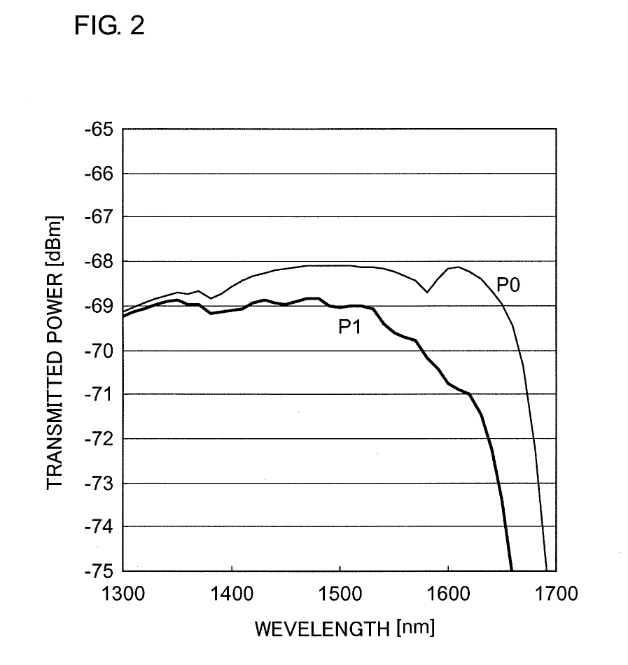

FIG. 2 is a graph showing the wavelength dependence of transmitted power Po of an optical fiber 1 measured at the first step and the wavelength dependence of transmitted power P₁ of the optical fiber 1 measured at the second step, respectively in a comparative example. In the comparative example, the bend-radius R of the optical fiber 1 was 5 mm, and the circumference of the optical fiber 1 was air. In the transmitted power P₁, there is an oscillatory component which depends on a wavelength unrelated to the wavelength dependence of the light power P₀ from the light source 3.

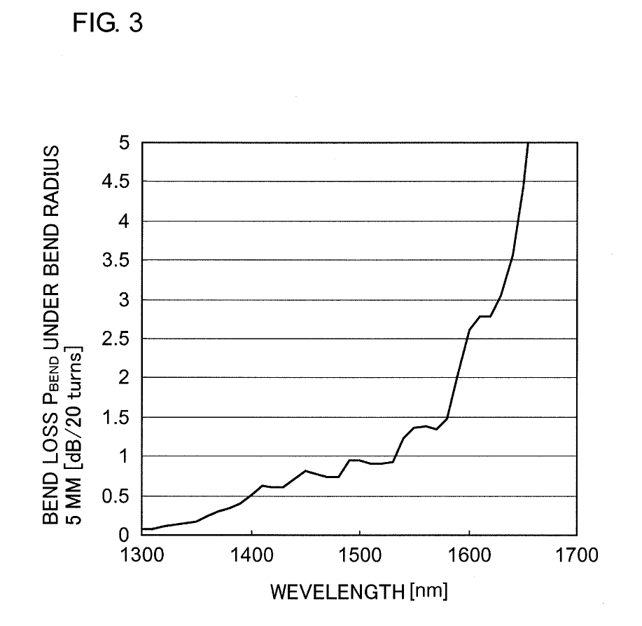

FIG. 3 is a graph showing the wavelength dependence of the difference P_{Bend} between the transmitted power Pₒ and the transmitted power P₁ of an optical fiber 1 in the comparative example. The oscillation of power which depends on a wavelength occurs in the difference P_{Bend}. As indicated in Non-patent literature 1, such oscillation is due to interference which occurs between core mode and whispering gallery mode when the whispering gallery mode combines with the core mode. This makes it difficult to achieve exact measurement of the bend loss of the optical fiber 1.

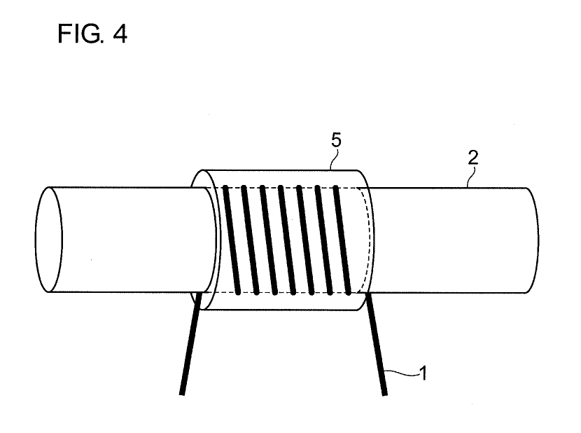

FIG. 4 is a drawing illustrating a second step in the method of one embodiment of the present invention for measuring bending performance of an optical fiber. At the second step in this embodiment, the transmitted power P1 is measured under conditions where an optical fiber 1 is wound at a constant pitch by one layer on the circumferential side of the mandrel 2 with a given diameter and the overall circumference of the optical fiber 1 thus wound is covered with an index matching sheet 5 having a refractive index which substantially matches the refractive index of resin in the outermost layer of the optical fiber 1. The index matching sheet 5 can be any one selected from the group consisting of urethane gel, urethane elastomer, and UV resin, for example. Under such conditions, much of the whispering gallery mode that has leaked out from the core of the optical fiber 1 because of a bend thereof will pass through the resin coating layer to the index matching sheet 5. Thus, the whispering gallery mode is prevented from recombining with the core mode.

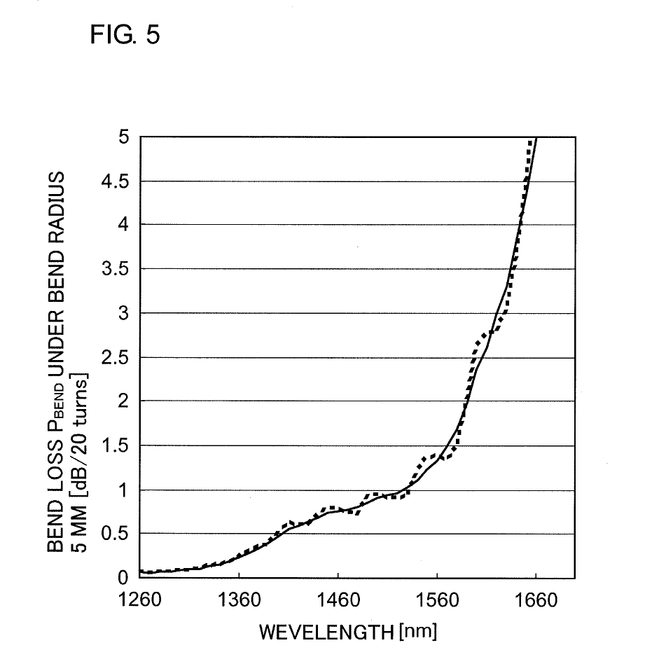

FIG. 5 is a graph showing the wavelength dependence of P_{Bend} which is a difference between transmitted powers P₀ and P₁. The solid line shows the results of measurement done according to the method of this embodiment for measuring bending performance of an optical fiber, and the dashed line shows those of measurement done with a conventional method. In this embodiment, the generation of wavelength-dependent oscillatory components in P_{Bend Bend} which is a difference between transmitted powers P₀ and P₁ is restrained, and accordingly the bend loss of the optical fiber 1 can be measured correctly in a simple manner. In this case, the refractive index of resin in the outermost layer of the optical fiber 1 was 1.52, and the refractive index of the index matching sheet 5 was 1.53.

Preferably, the difference between the refractive index of the index matching sheet 5 and the refractive index of resin in the outermost layer of the optical fiber 1 is ±0.3 or less, and more preferably the difference is ±0.1 or less. Thus, by lessening the difference between the refractive index of the index matching sheet 5 and the refractive index of resin in the outermost layer of the optical fiber 1 so that whispering gallery mode leaks out from the resin-coating layer effectively to the index matching sheet 5, it is made possible to measure the bend loss of the optical fiber 1 more correctly.

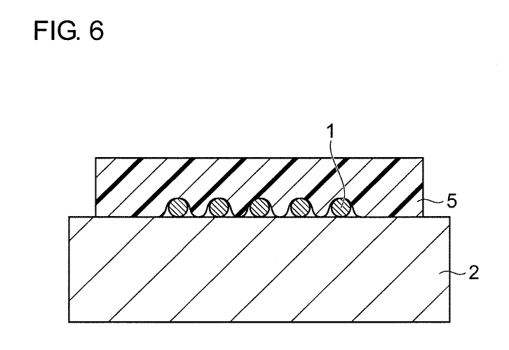

FIG. 6 is a drawing illustrating a part of section of a mandrel 2 around which an optical fiber 1 and an index matching sheet 5 are wound at the second step in the method of the present invention for measuring bending performance of an optical fiber.

The compression elasticity modulus of the index matching sheet 5 is preferably 50 N/mm² or less, and more preferably 30 N/mm² or less. Thus, by lessening the compression elasticity modulus of the index matching sheet 5, the overall circumference of the fiber 1 that is wound around the mandrel 2 can be covered with the index matching sheet 5 in such a surrounding manner as to decrease the resin-air interface area. Consequently, the whispering gallery mode will be made to go out more effectively from the resin coating layer to the index matching sheet 5. This will enable measuring the bend loss of the optical fiber 1 more correctly.

It is desirable that the force of the index matching sheet 5 which presses the overall circumference of the optical fiber 1 be 200 g or less. Thus, the increase in micro bend loss due to the stress to the optical fiber 1 will be restrained, allowing exact measurement of bend loss. Preferably, the force with which the circumference of the optical fiber 1 is pressed by the index matching sheet 5 is 50 g or less.

In the case of measuring the cutoff wavelength of the optical fiber 1, the bend loss of high order mode is measured by affording a bend to the optical fiber 1. There is a case where the influence of whispering gallery mode appears similarly to high order mode, thereby decreasing accuracy in the measurement of a cutoff wavelength. In the method of the embodiment of the present invention for measuring bending performance of an optical fiber, it is also possible to restrain the influence of whispering gallery mode in measurement of cutoff wavelength, thereby preventing the degradation of measurement accuracy.

What is claimed is:

1. A method for measuring bending performance of an optical fiber comprising:
a first step of measuring power P₀ of light emitted from an end of an optical fiber when light is incident on the other end of the optical fiber under conditions where no bend loss occurs in the optical fiber;
a second step of winding the optical fiber around a mandrel with a diameter 2R and covering the overall outer circumference of such wound optical fiber with an index matching sheet and subsequently measuring power P₁ of light emitted from one end of the optical fiber when light is incident on the other end of the optical fiber, whereas the refractive index of the index matching sheet substantially matches with the refractive index of resin in the outermost layer of the optical fiber; and
a third step of measuring, based on the power P₀ measured at the first step and the power P₁ measured at the second step, bend loss of the optical fiber when the optical fiber is bent at the diameter 2R.

2. The method for measuring bending performance of the optical fiber according to claim 1, wherein the difference between the refractive index of the index matching sheet and that of resin in the outermost layer of the optical fiber is ±0.3 or less.

3. The method for measuring bending performance of the optical fiber according to claim 1, wherein
the difference between the refractive index of the index matching sheet and that of resin in the outermost layer of the optical fiber is ±0.1 or less.

4. The method for measuring bending performance of the optical fiber according to claim 1, wherein the compression elasticity modulus of the index matching sheet is 50 N/mm² or less.

5. The method for measuring bending performance of the optical fiber according to claim 1, wherein
the compression elasticity modulus of the index matching sheet is 30 N/mm² or less.

6. The method for measuring bending performance of the optical fiber according to claim 1, wherein
the index matching sheet is made of any one selected from the group consisting of urethane gel, urethane elastomer, and UV resin.
